(19) United States
(12) Patent Application Publication
(10) Pub. No.: US 2021/0224863 A1
(43) Pub. Date: Jul. 22, 2021

(54) ON-LINE ADVERTISING SYSTEM WITH ON-NETWORK AD DELIVERY

(71) Applicant: Unified Commerce Company, LLC, Cheyenne, WY (US)

(72) Inventors: Brian Royce, Houston, TX (US); Terry Easton, San Francisco, CA (US); Kayla R. Paul, Houston, CA (US)

(73) Assignee: Unified Commerce Company, LLC, Cheyenne, WY (US)

(21) Appl. No.: 17/151,129

(22) Filed: Jan. 16, 2021

Related U.S. Application Data
(60) Provisional application No. 62/962,451, filed on Jan. 17, 2020.

(51) Int. Cl. G06Q 30/02; G06Q 10/08; G06F 16/22; G06F 16/955

(52) U.S. Cl. CPC G06Q 30/0277; G06Q 10/087; G06Q 30/0255; G06Q 30/0253; G06F 16/22; G06F 16/9566; G06Q 30/0246

(57) ABSTRACT

A computerized advertising delivery system and method employs a product database that stores information that associates each of a plurality of hostnames with one or more products. An ad server retrieves ad meta-data associated with an ad stored in the ad database, where the ad meta-data specifies one or more products associated with the ad. The ad meta-data is compared to product data stored in the product database to identify one or more hostnames specifying information regarding products associated with the ad. The ad is delivered for presentation in connection with content associated with a uniform resource locator, accessible by a first hostname, stored in the ad database. The ad is further encoded with a second uniform resource locator associated with the first hostname, to cause content associated with the second uniform resource locator to be provided to the first user upon interaction with the ad.

### RELATED APPLICATIONS

This application claims priority to U.S. patent application 62/962,451 filed on Jan. 17, 2020 and entitled Unified Commerce Cloud Platform, which application is assigned to the assignee of the present application and which is hereby incorporated by reference in its entirety.

This application is related to PCT patent application entitled RETAIL PLATFORM WITH INTEGRATED INVENTORY AND PAYMENT, filed on the same day as the present application, which application is assigned to the assignee of the present application and which is hereby incorporated by reference in its entirety.

This application is related to U.S. patent application entitled ON-LINE ADVERTISING SYSTEM WITH UNIVERSAL PRODUCT CODE BASED AD DELIVERY, filed on the same day as the present application, which application is assigned to the assignee of the present application and which is hereby incorporated by reference in its entirety.

### FIELD OF THE DISCLOSURE

This disclosure relates generally to the field of data processing systems and more particularly to computerized electronic commerce.

### BACKGROUND

Usage of on-line advertising continues to grow as individuals increasingly use computers to search for, browse and to purchase products and services for consumer and business purposes. The computers used can include general purpose computers like desktops, laptops, tablets, smartphones, and specialized systems such as kiosks. As the usage of on-line shopping increases there is a need for new on-line advertising systems and methods to provide advertisers with greater flexibility and choice in directing their advertising content.

### SUMMARY

A computerized advertising system and method is disclosed herein that includes in a system embodiment, an ad database that stores a plurality of ads, where each ad provides content, in association with a uniform resource locator, to be consumed by a user. A product database stores information that associates each of a plurality of hostnames with one or more products, where each hostname is immediately inferior to a top-level domain in an internet domain name space. An ad server is programmed with computer-executable instructions that when executed, cause the ad server to retrieve ad meta-data associated with an ad stored in the ad database, where the ad meta-data specifies one or more products associated with the ad. The ad server compares the ad meta-data to product data stored in the product database to identify one or more hostnames specifying information regarding products associated with the ad. The ad server delivers the ad for presentation to a first user in connection with content associated with a uniform resource locator, accessible by a first hostname, stored in the ad database. The ad server further encodes the ad with a second uniform resource locator associated with the first hostname, to cause content associated with the second uniform resource locator to be provided to the first user upon interaction with the ad by the first user.

In another aspect, the disclosed computerized advertising delivery system includes a registry for storing a plurality of on-network hostnames. The ad server delivers the ad for presentation to a second user in connection with content associated with a uniform resource locator which is accessible by a second hostname stored in the registry as an on-network hostname, stored in the ad database. The ad server further encodes the ad with a second uniform resource locator associated with the second hostname, to cause content associated with the second uniform resource locator to be provided to the second user upon user interaction with the ad.

In another aspect, the ad meta-data associated with the ad stored in the ad database includes an on/off network flag. The ad server checks the on/off network ad flag, and if the on/off network ad flag indicates an on-network ad then the ad server encodes the ad with the second uniform resource locator associated with the first hostname. If the on/off network ad flag indicates an off-network ad then the ad server encodes the ad with the second uniform resource locator associated with a second hostname that is different from the first hostname.

These and additional aspects related to the invention will be set forth in part in the description which follows, and in part will be apparent to those skilled in the art from the description or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive techniques disclosed herein. Specifically:

FIG. 1 is a high-level block diagram of a computerized advertising system embodying the principles described herein.

FIGS. 2A, 2B, 2C, 2D and 2E are illustrations of sample advertising placement on a webpage.

FIG. 3 is a flow diagram illustrating operation of the embodiment shown in FIG. 1.

FIG. 4 is a flow diagram illustrating operation of the ad server of FIGS. 1 and 3.

FIG. 5 is a flow diagram illustrating further details of off and on-network advertisements.

FIGS. 6-1 and 6-2 are flow diagrams illustrating operation of ad creation and display.

FIG. 7 illustrates a block diagram of hardware that may be employed in an implementation of the embodiments disclosed herein.

### DETAILED DESCRIPTION

In the following detailed description, reference will be made to the accompanying drawings, in which identical functional elements are designated with like numerals. Elements designated with reference numbers ending in a suffix such as .1, .2, .3 are referred to collectively by employing the main reference number without the suffix. For example, 100 refers to topics 100.1, 100.2, 100.3 generally and collectively. The aforementioned accompanying drawings show by way of illustration, and not by way of limitation, specific embodiments and implementations consistent with principles of the present invention. The block diagrams and flow diagrams in the drawings illustrate operations and do not necessarily represent physical connections between any particular blocks or modules. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense.

Reference is made in this specification to various aspects of websites available via the internet. As used herein, in a Uniform Resource Locator (URL), for example, “http://www.example.com”, moving from right to left in the URL, the “.com” label is referred to as a top-level domain. Moving to the left, each label specifies a sub domain of the domain to the right. So, the label “example” specifies a subdomain of the top-level domain label “.com”, and the label “www” specifies a subdomain of the subdomain “example”. For simplicity of reference the first subdomain of the top-level domain may be referred to as a first level subdomain and a subdomain of the first level subdomain may be referred to as a second level subdomain, and this nomenclature can be extended for further level subdomains (third level, fourth level, etc.). In the foregoing example, the “http” designation refers to a protocol, in this case, the hypertext transfer protocol. In the URL http://www.example.com, the labels www.example.com may also be referred to as a hostname. A URL may also include a path component, consisting of a sequence of path segments separated by a slash (/), to, for example, specify a particular file to be provided to a user, such as by being rendered on a browser. For example, a URL such as www.example.com/first_file.html, when accessed by a user's browser will cause the file named “first_file.html” located at hostname www.example.com to be rendered on the user's browser. The path component may specify multiple levels such as for example, www.example.com/special/second_file.html. In such an example, the file named “second_file.html” located in a folder named “special” that is located at hostname www.example.com when accessed by a user's browser will be rendered by the browser. In the foregoing example, the files that are rendered on a user's browser, such as “first_file.html” and “second_file.html” may also each be referred to as a “webpage”. In the foregoing example, the webpages “first_file.html” and “second_file.html” may be referred to as being within or accessible by the hostname “example.com”.

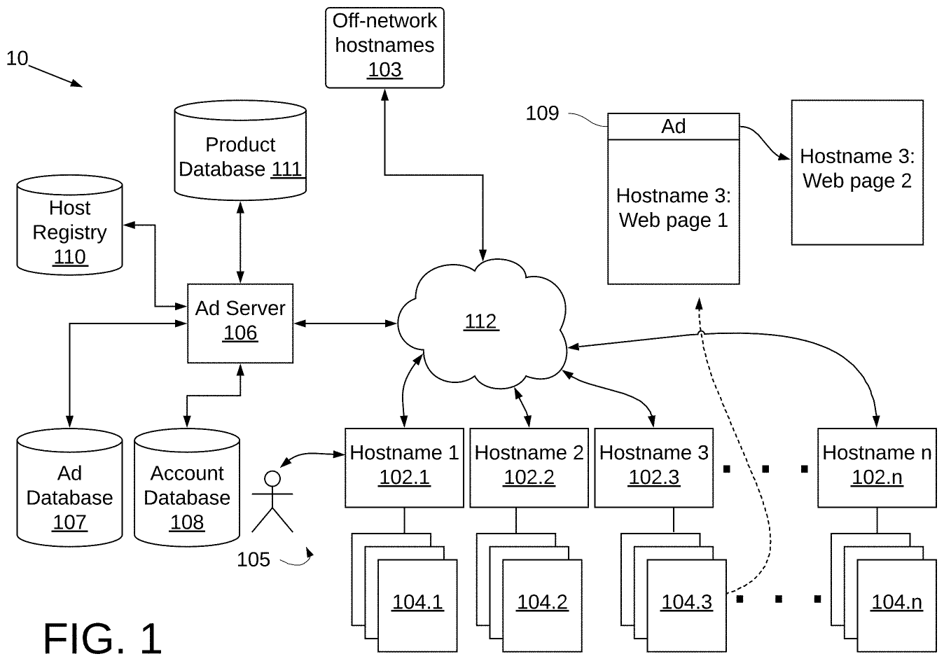

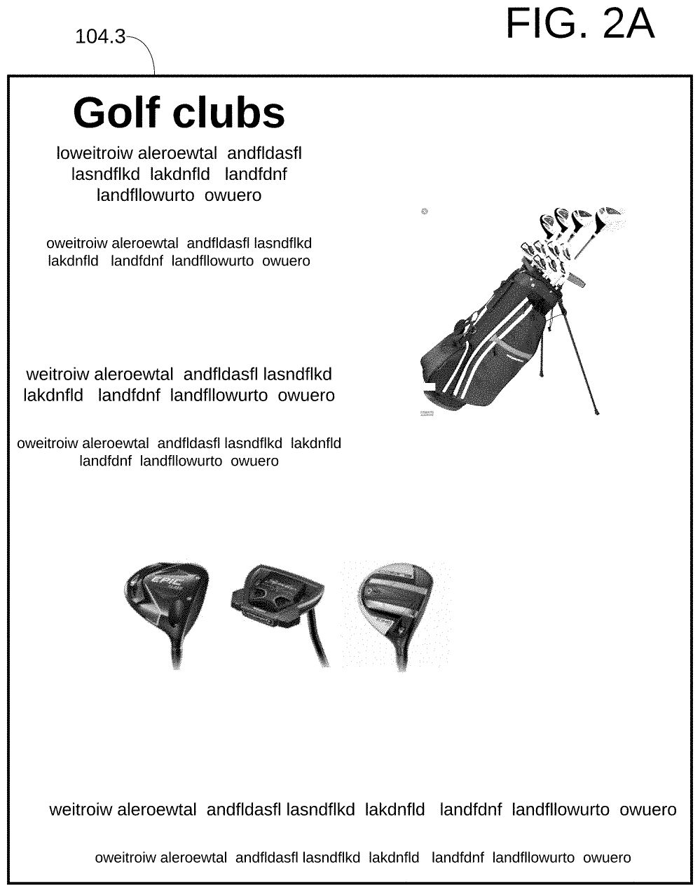

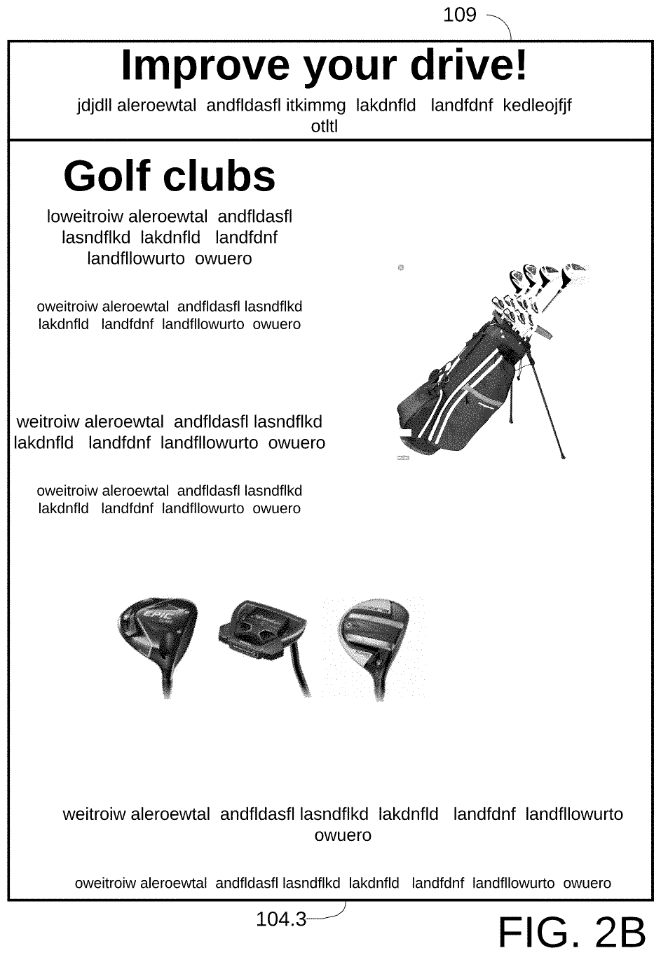

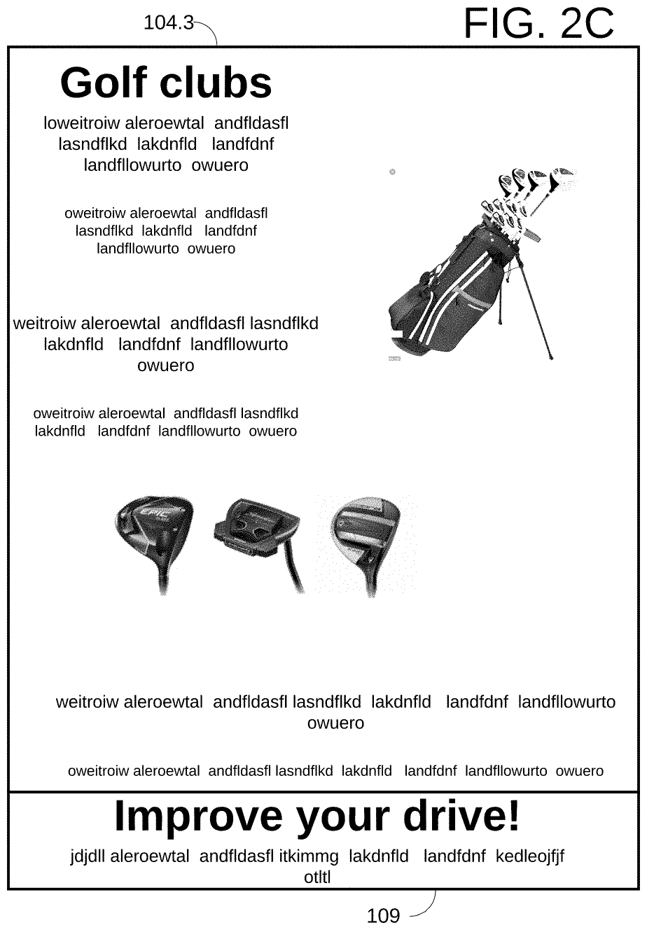

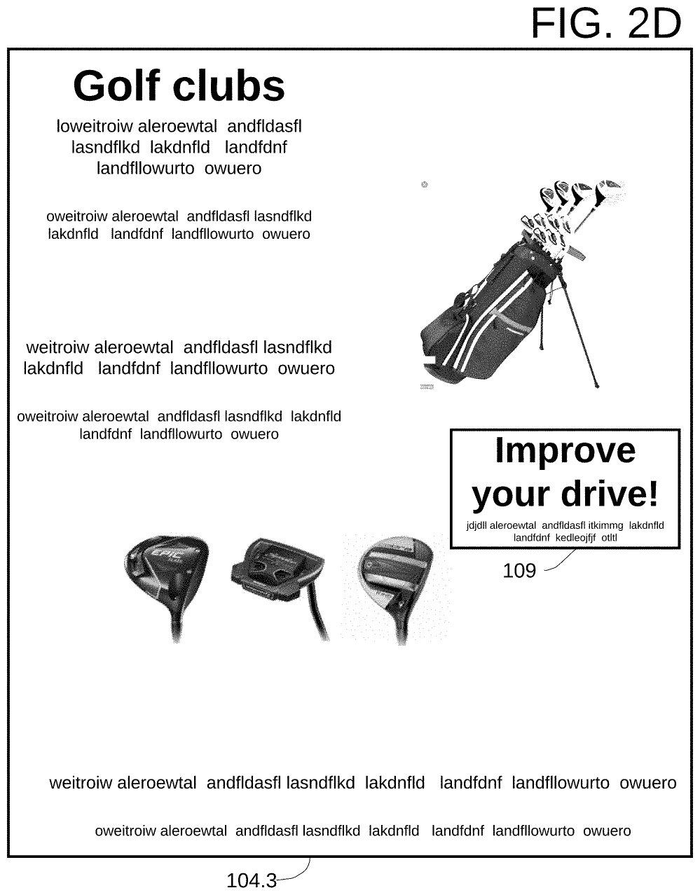

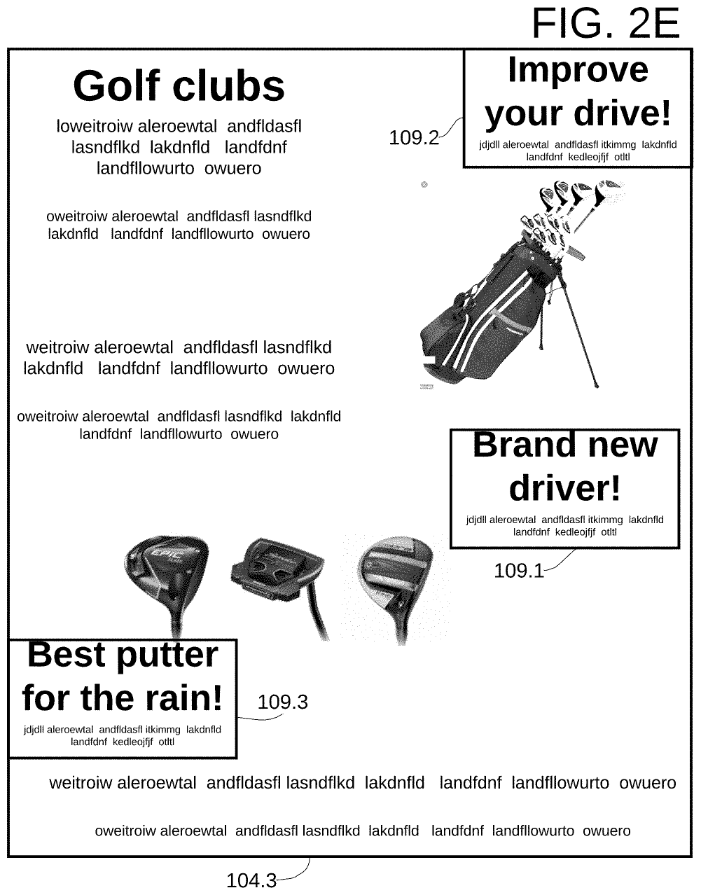

FIG. 1 is a high-level block diagram of a computerized advertising system 10 embodying the principles described herein. A plurality of hostnames 102 (also referred to as on-network hostnames 102) seen at 102.1, 102.2, 102.3, . . . , 102.n are shown. Also shown are one or more off-network hostnames 103. Each of the hostnames has associated there with one or more web pages 104, each designated by a URL. Specifically seen are one or more web pages 104.1, 104.2, 104.3, . . . , 104.n. The hostnames 102 and webpages 104 may be conventional, as implemented by conventional, commercially available hardware and software, for use by a user 105. Ad server 106 operates to retrieve ads from ad database 107 for delivery to hostnames 102 and off-network hostnames 103. Each of the hostnames 102 and certain of the off-network hosts 103 maintains an account with ad server 106 to track payment and other account related information, which is stored in account database 108. An example of an ad 109 added to a web page is seen at 104.3 where web page 1, associated with hostname 3 has an ad 109 added thereto within a zone (as further explained in connection with FIGS. 2A-2E).

Host registry 110 has stored therein information pertaining to on-network hostnames 102. Registration in host registry 110 distinguishes between on-network hostnames 102 and off-network hostnames 103. The registration of a hostname 102 in host registry 110 permits ad server 106 to place an advertisement on a webpage provided by the registered hostname 102 where the placed advertisement, when clicked (or otherwise selected) by a user directs the user to another webpage provided by the same hostname. In certain embodiments, the registration via host registry 110 also permits tracking by the ad server 106 of advertisements that may be placed by a source other than ad server 106 on any webpages provided by the registered hostname 102. This tracking may be performed in one embodiment by placement of a conventional tracking cookie which permits tracking of a user's actions on a particular hostname. Registration of a hostname 102 via registry 110 permits end to end tracking of a user's actions with respect to a webpage on which the ad server 106 has placed an advertisement. This permits generation of a click path (also referred to as a “clickstream”) to permit analysis of the user's actions, thereby permitting more precise advertisement targeting. This tracking may be performed by way of website analysis software executing on an on-network hostname 102 and/or by way of conventional cookies. In certain embodiments, the registration via host registry 110 also permits tracking of inventory for a retailer associated with the registered hostname 102. This increases the effectiveness of product specific advertisements placed by ad server 106 on a webpage provided by a registered hostname 102 by providing an advertisement for a specific product only if the product is contained in an inventory of the retailer associated with the registered hostname 102. Prior to placing a product specific advertisement, the ad server 106 checks inventory of the retailer associated with the registered hostname 102 to determine if the product pertaining to the product specific advertisement is present in the inventory of the retailer and if so, then permits the advertisement to be placed on the designated webpage. The ad 109 may, and often will typically, be provided to the ad database 107 by an entity different than that associated with the hostname upon whose webpage the ad 109 is displayed. This is different than a conventional operation where an ad by one entity typically directs the user to a webpage provided by the entity providing the ad. The ad 109 may also be dynamically generated, to be customized in part to the user seeing the ad, as opposed to being a static ad that is the same for each user. Each entity that provides ads for the ad database 107 is identified in the ad database, and in some embodiments also the account database 108. The ad 109 may be customized based on the user's activities and other data pertaining to the user to customize the ad 109 to the user. For example, ad 109 may have content that is different from one user to another user and may direct the different users to different content (webpages). Placement of the ad 109 also causes an update to a payment field of the ad database 107 and/or account database 108 to debit an account of the source of the ad 109. An account of the retailer associated with the hostname 102 upon whose webpage the ad has been placed is credited for placement of the ad 109. In certain embodiments, a third-party such as an operator of the system 10 may also be credited with a portion of the amount debited from the advertiser's account.

Product database 111 has stored therein information pertaining to products that are described and that may be available for sale by way of web pages 104. Product database 111 has stored therein information pertaining to products that are described and that may be available for sale by way of web pages 104. Product database 111 contains information about each product shown on each webpage 104 of each on-network hostname 102. In the embodiment shown in FIG. 1, each row of product database 111 corresponds to a specific product identified by a product ID, that uniquely identifies a particular product for a particular hostname 102. The product database 111 also identifies a product by way of a UPC and the UPC uniquely identifies each product across all hostnames (both on-network and off-network). Each product in the product database 111 also has associated therewith a common product name. For example, the common product name for any given product may be the model name for the product. For example, a putter made of titanium from the Acme Golf Company may have as its common product name the model name assigned to its, such as “Titanium Champion Putter”.

Ad database 107 stores ads for use with on-network hostnames 102 and off-network hostnames 103 advertising. As seen in FIG. 1, in on-network advertising, interaction by a user 105 on an ad 109 (such as by clicking or selecting the ad) displayed in connection with a webpage (such as webpage 1 associated with on-network hostname 3) takes the user to another webpage (such as webpage 2) on the same hostname. In another embodiment the destination webpage (i.e., webpage 2) may be on another on-network hostname. In off-network advertising, clicking by user 105 on an ad 109 takes the user 105 to an off-network hostname 103.

The databases 107, 108, 111 and registry (which can take the form of a database) 110 are shown separately for purposes of explaining the embodiments described herein. The form, format and organization of the databases 107, 108, 111 and registry 110 may vary without departing from the principles described herein. For example, the databases 107, 108, 111 and registry 110 may be combined in a variety of ways or may be further separated into more granular data storage facilities. Communication between the ad server 106, the on-network hostnames 102 and off-network hostnames 103 in one embodiment maybe by conventional networking capabilities 112 which may include private networks and the public Internet.

FIGS. 2A, 2B, 2C, 2D and 2E are illustrations of sample advertising placement on a webpage. In FIG. 2A a rendering of a conventional webpage 104.3 is shown by way of example. As seen, the webpage may have a combination of text and images, and also video and/or audio (not shown). FIG. 2B shows an enlargement of the example in FIG. 1 of webpage 104.3 with an ad 109 appended to the top of the webpage 104.3. FIG. 2C shows a variant of FIG. 2B with the ad 109 now being appended to the bottom of the webpage 104.3. FIG. 2D shows another variant with the ad 109 being placed within the boundaries of the webpage 104.3. FIG. 2E shows another variant with multiple ads 109 (109.1, 109.2, 109.3) being placed within the boundaries of the webpage 104.3. Other variants may be used, such as placing the ad 109 to the left side, right side or elsewhere relative to the webpage 104.3.

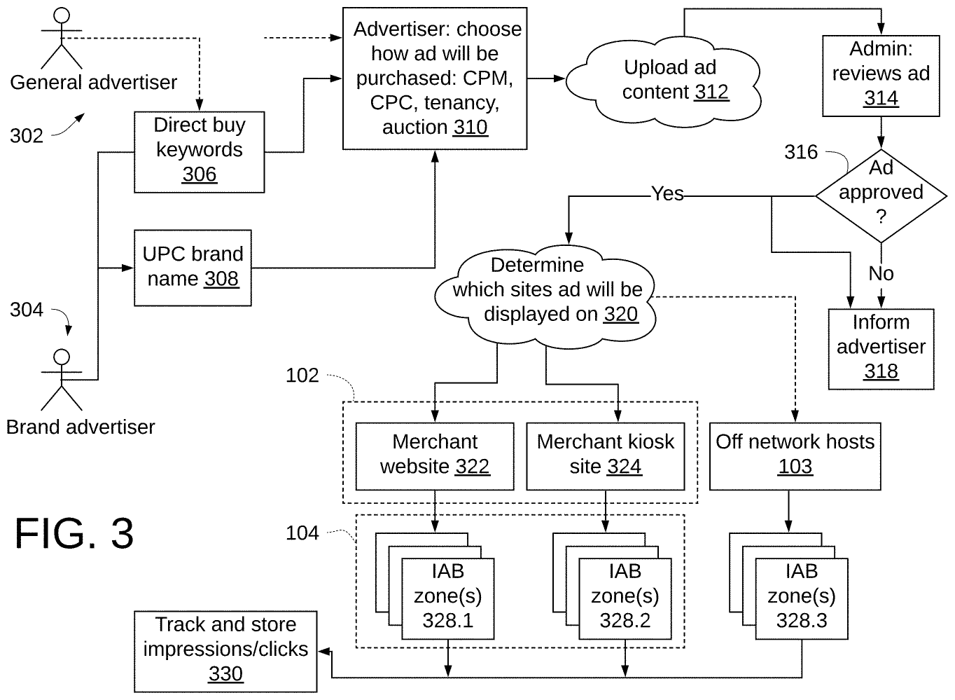

FIG. 3 is a flow diagram illustrating operation of the system 10 shown in FIG. 1. As seen, a general advertiser, user 302, may use the system as well as a brand advertiser, user 304. A general advertiser seeks placement of ads to increase awareness of an organization, issue, etc. whereas a brand advertisement seeks placement of ads to increase awareness of one or more brands under which various products/services are offered for sale. General advertiser 302 specifies one or more keywords/phrases that may cause placement of ads specified by the general advertiser 302. Brand advertiser may specify keywords 306 and may also specify products by way of Universal Product Codes (UPC) 308. UPC codes are widely used to track trade items in stores and typically consist of numeric digits (e.g. 12 digits for many of the UPC standards) that are uniquely assigned to each trade item. The unique product identification capability of a UPC code permits selection by a brand advertiser of one or more products to which the brand advertiser may direct ads from ad database 107. Each advertiser 302, 304 selects at 310 the pricing metric by which selected ad(s) will be purchased. A variety of pricing metrics maybe employed including Cost Per iMpression (CPM), Cost Per Click (CPC), tenancy, and auction. In a CPM pricing model, the advertiser is charged when the advertiser's ad is presented to a user. In a CPC pricing model, the advertiser is charged when the advertiser's ad is presented to a user who then “clicks” or performs some other action to select the ad, which typically causes the user to be directed to another URL, and in embodiments disclosed herein, to a URL at the same hostname. In a tenancy pricing model, the advertiser pays for a certain amount of space for display of their ad(s) for a particular amount of time. In an auction pricing model, ad space is offered to multiple potential advertisers. The advertiser 302/304 also uploads ad content at 312 to the ad database 107. Uploaded ads 109 may be reviewed at 314 by an administrator (admin) for compliance with various system policies. The advertiser 302/304 is informed at 318 of whether or not the ad 109 has been approved at 316. If the ad 109 is approved, it is available for serving by the ad server 106, which at 320 determines which sites (webpages in hostnames 102 and off-network hostnames 103) the various ads in ad database 107 should be displayed on. The on-network hostnames 102 may take several forms including a website that is accessible by a browser executing on a conventional computing device and a specialized device such as a kiosk that provides a limited user interface to provide or product browsing and/or purchasing. Off-network hostnames 103 may similarly take a variety of forms. Each ad 109 supplied by the ad server 106 is provided to a browser or similar application encoded to request an ad 109 upon encountering an appropriate command when rendering a web page 104. The ad 109 delivered by the ad server 106 is rendered in a predetermined space (zone) 328 within the webpage 104. The zone 328, such as the zones 328.1, 328.3, 328.3, may be a zone as specified by the Interactive Advertising Bureau (IAB) to facilitate on-line advertising. The ads 109 may be of a variety of types including display ads, native ads, emoji ads, 360-degree image and video ads, virtual reality ads and augmented reality ads. User interaction with the ads 109 provided to the web pages 104 is tracked and stored at 330.

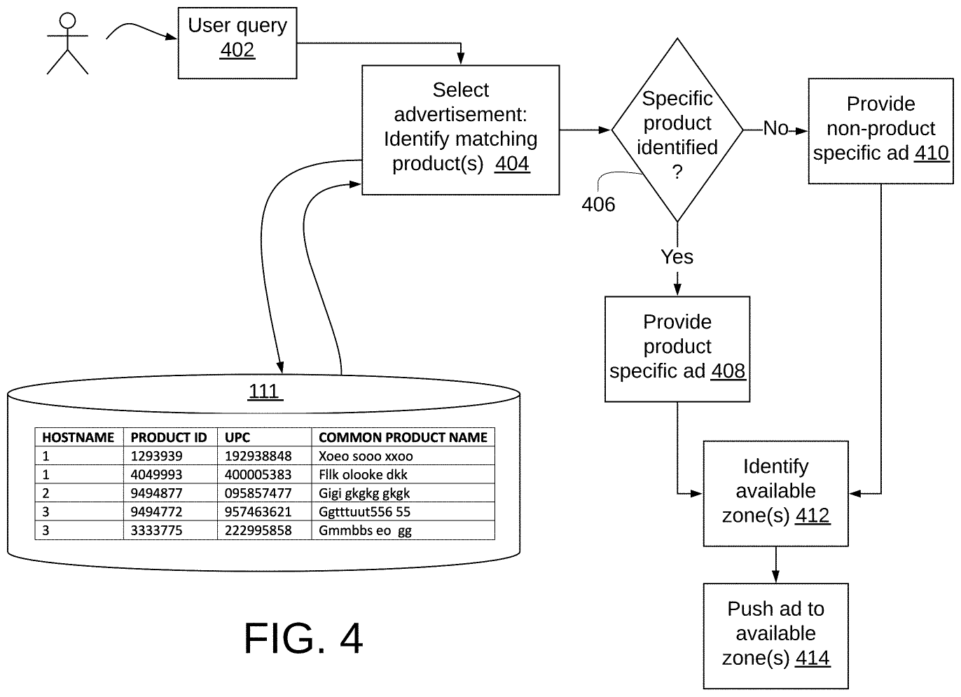

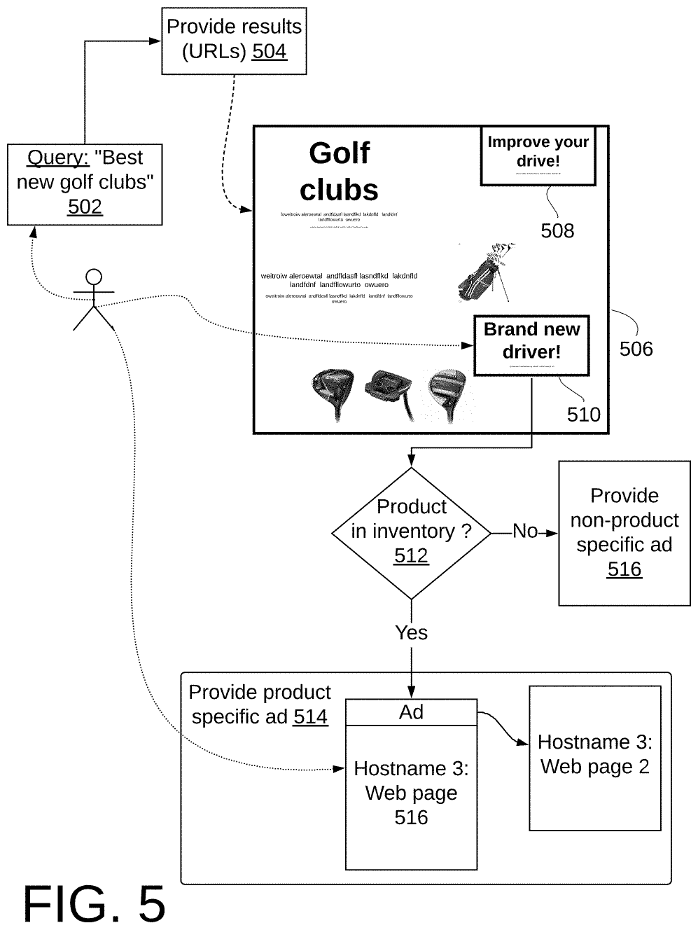

Further details of operation of ad server 106 and in particular of operation 320 of FIG. 3 such as to provide product specific ads to the web pages 104 are shown in FIG. 4. The ad server 106 selects a product specific advertisement at 404 by identifying one or more matching products. This is performed by querying product database 111 to identify a product that corresponds to a particular identifier such as a product ID or a Universal Product Code (UPC). The product identification is performed in one embodiment by performing a match of a user entered query term(s) 402 to one or more common product name(s) in product database 111 which contains a variety of information regarding each product available for sale on any of the webpages 104 on the on-network hostnames 102. The product database 111 employ a synonym database to provide more robust processing of a query in identifying matching product(s). In the embodiment shown in FIG. 4, the user query 402 must result in identification of a product in question with some reasonable particularity to enable matching with a common product name stored in the product database 111. The particular term may be directly entered by the user or may be generated by processing a more generalized query to generate the query 402. The matching performed at 404 may be performed conventionally to permit variants of the query 402 to be identified in the common product name field to be identified as a match. The results of the matching performed at 404 is checked at 406 to determine if a specific product (corresponding to one or more UPCs has been identified). If so, then at 408 a product specific ad is provided. If not then at 410 a more generalized ad, that is not product specific is provided. The operation at 408 in certain embodiments may also involve checking for availability of the identified product, as described in connection with FIG. 5. Available zone(s) in the target webpage are identified at 412 and the ad is provided to one of the available zones at 414.

Selection of an advertisement 109 by the ad server 106 at 408 and 410 may be performed in accordance with conventional techniques. In one embodiment, the selection is performed in accordance with a variety of factors including the frequency desired by the advertiser, the amount the advertiser wishes to spend, and the amount of funds remaining in an advertiser's account. In another embodiment criteria for matching an ad 109 to a product may be a UPC provided by a brand advertiser 304 as described in connection with FIG. 3. The criteria may also be keywords or phrases such as selected by either a general advertiser 302 or a brand advertiser 304. Matching of an ad 109 to a product by way of a UPC is performed by correlating a product name to a UPC.

An ad 109 may be generated directly in response to a user query such as described above in connection with FIG. 4 or may also be generated by user selection of an ad. This is illustrated in FIG. 5 where a user generates a query 502 “Best new golf clubs.” Such a query may be entered into a conventional search engine and may generate a number of results 504 (URLs). Selection of a particular URL results in presentation of a web page 506 to the user. The web page 506 contains various content in the form of images, text, and/or video, sound. The content may also include one or more ads such as seen at 508/510. Selection by the user of a particular ad, such as 510, which pertains to a particular specific product, results in presentation of another ad to the user. A test is performed at 512 to determine if the specific product is currently in the inventory of a merchant associated with the webpage 506. If so, then at 514 a product specific webpage 516 is provided to the user from the hostname in question, here hostname 3. Such a webpage 516 may offer for example the user a discount on the product in question and provide a simplified purchasing interface to increase the chances that the user will purchase the product in question. As shown, the webpage 516 may itself contain an ad that leads to another on-network webpage associated with hostname 3. If at 512 it is determined that the product in question is not in inventory, then the user is presented with an ad that is not product specific. This avoids generation of an expectation in the user when presented with product specific information that the product in question is available for purchase.

FIGS. 6-1 and 6-2 are flow diagrams illustrating operation of ad creation and display as initiated by a brand advertiser 304 who may perform a UPC ad buy 602 or a Brand name ad buy 604. The UPC ad buy 602 is performed by creating an ad 109 at UPC ad creation 606. A check is performed at 608 to determine if a UPC matching that entered by the brand advertiser 304 exists in the product database 111. If not, an error message is provided at 610. If so, then at 612 the content of the ad 109 is uploaded to the ad database 107. A Brand name ad buy 604 is initiated at 614 by brand ad creation at 614. A check is performed at 616 to determine if the brand in question has been claimed by the brand advertiser 304. This is performed to limit brand ads to be provided by ad server 106 for only the brands owned by the brand owner. This prevents a brand owner X to cause their brand to be provided in connection with a brand owned by a different entity Y. If at 616 the brand in question has not been claimed by the advertiser 304 an error message is provided to cause the brand advertiser to register the brand in question with the account database 108 or to change the brand. Otherwise at 620 the content for the ad in question is uploaded to the ad database 107.

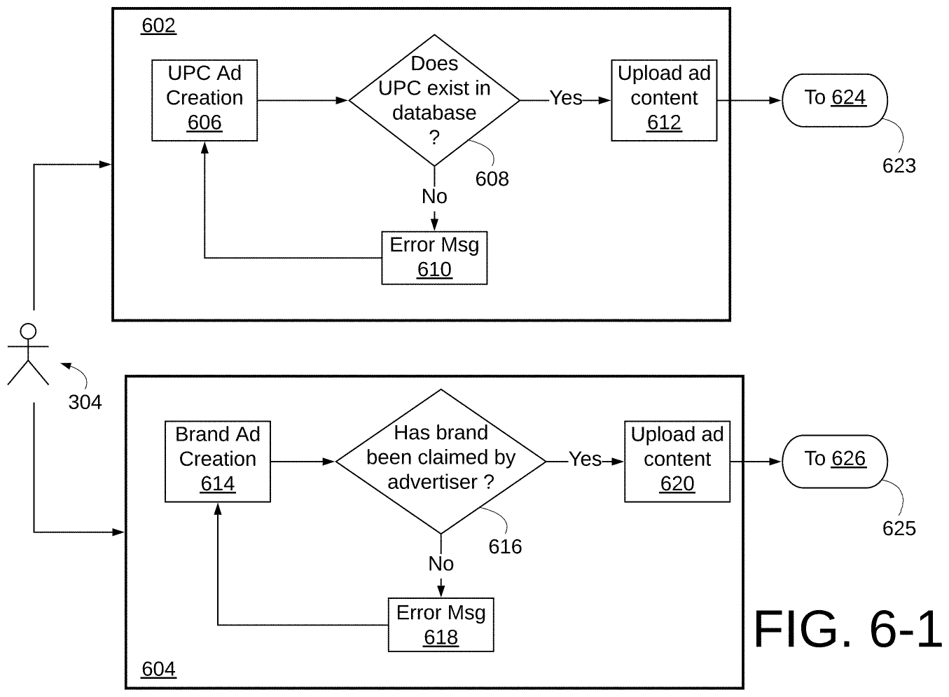

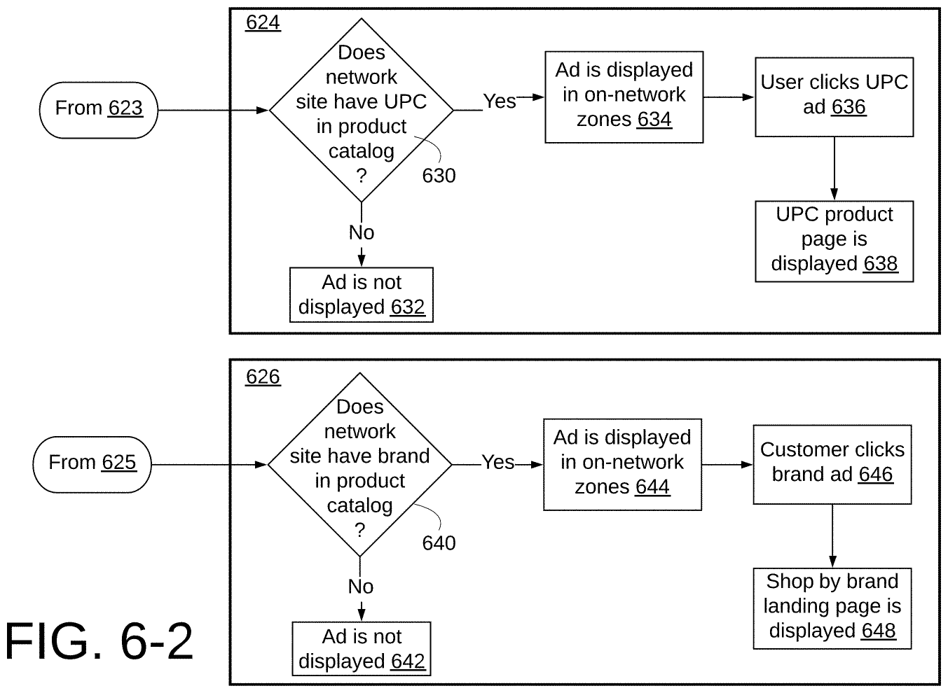

The operations in FIG. 6-1 are continued as shown in FIG. 6-2. Upon uploading of ad content at 612, a test is performed at 630 to determine if the hostname specified by the brand advertiser 304 to receive the ad in question has the specified UPC in its product inventory. If not, the ad in question is not displayed as shown at 632. If so, at 634 the ad is displayed at 634 in the on-network zones on the webpage(s) 104. Upon a user clicking at 636 on the ad in question, a product page as contained on a webpage 104 is provided to the user at 638.

For the Brand name ad buy 604, after operation 620 in FIG. 6-1, a test is performed at 640 to determine if the hostname in question has the brand in question stored in the product database 111. If not then as seen at 642, the ad is not displayed. If so, then at 644, the ad in question is is displayed in on network zones contained in webpage(s) 104. Upon a user clicking at 646 on the brand ad in question, a shop by brand page as contained on a webpage 104 is provided to the user at 648.

The embodiments herein can be implemented in the general context of computer-executable instructions, such as those included in program modules, being executed in a computing system on a target real or virtual processor. Generally, program modules include routines, programs, libraries, objects, classes, components, data structures, etc. that perform particular tasks or implement particular abstract data types. The program modules may be obtained from another computer system, such as via the Internet, by downloading the program modules from the other computer system for execution on one or more different computer systems. The functionality of the program modules may be combined or split between program modules as desired in various embodiments. Computer-executable instructions for program modules may be executed within a local or distributed computing system. The computer-executable instructions, which may include data, instructions, and configuration parameters, may be provided via an article of manufacture including a computer readable medium, which provides content that represents instructions that can be executed. A computer readable medium may also include a storage or database from which content can be downloaded. A computer readable medium may also include a device or product having content stored thereon at a time of sale or delivery. Thus, delivering a device with stored content, or offering content for download over a communication medium may be understood as providing an article of manufacture with such content described herein.

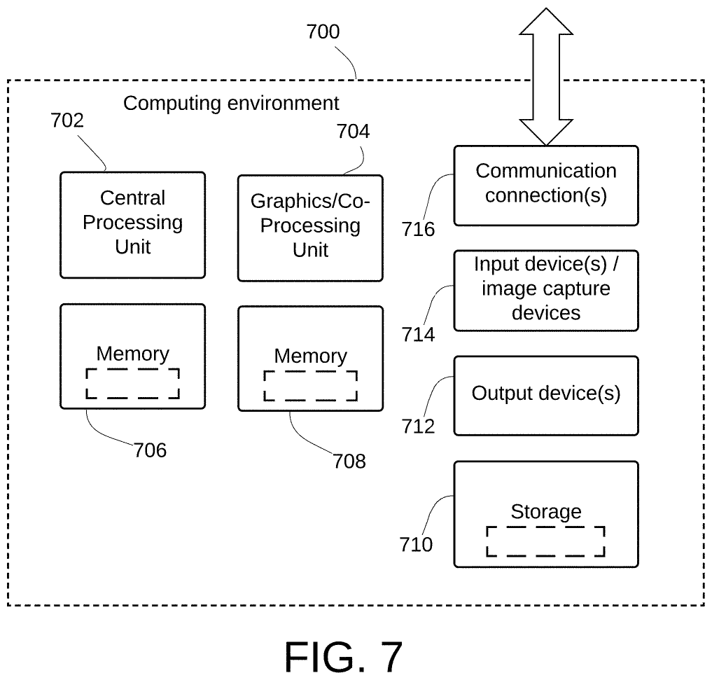

FIG. 7 illustrates a block diagram of hardware that may be employed in an implementation of the embodiments disclosed herein. FIG. 7 depicts a generalized example of a suitable general-purpose computing system 700 in which the described innovations may be implemented in order to improve the processing speed and efficiency with which the computing system 700 operates to perform the functions disclosed herein. With reference to FIG. 7 the computing system 700 includes one or more processing units 702, 704 and memory 706, 708. The processing units 702, 706 execute computer-executable instructions. A processing unit can be a general-purpose central processing unit (CPU), processor in an application-specific integrated circuit (ASIC) or any other type of processor. The tangible memory 706, 708 may be volatile memory (e.g., registers, cache, RAM), non-volatile memory (e.g., ROM, EEPROM, flash memory, etc.), or some combination of the two, accessible by the processing unit(s). The hardware components in FIG. 7 may be standard hardware components, or alternatively, some embodiments may employ specialized hardware components to further increase the operating efficiency and speed with which the system 10 operates. The various components of computing system 700 may be rearranged in various embodiments, and some embodiments may not require nor include all of the above components, while other embodiments may include additional components, such as specialized processors and additional memory.

Computing system 700 may have additional features such as for example, storage 710, one or more input devices 714, one or more output devices 712, and one or more communication connections 716. An interconnection mechanism (not shown) such as a bus, controller, or network interconnects the components of the computing system 700. Typically, operating system software (not shown) provides an operating system for other software executing in the computing system 700, and coordinates activities of the components of the computing system 700.

The tangible storage 710 may be removable or non-removable, and includes magnetic disks, magnetic tapes or cassettes, CD-ROMs, DVDs, or any other medium which can be used to store information in a non-transitory way, and which can be accessed within the computing system 700. The storage 710 stores instructions for the software implementing one or more innovations described herein.

The input device(s) 714 may be a touch input device such as a keyboard, mouse, pen, or trackball, a voice input device, a scanning device, or another device that provides input to the computing system 700. For video encoding, the input device(s) 714 may be a camera, video card, TV tuner card, or similar device that accepts video input in analog or digital form, or a CD-ROM or CD-RW that reads video samples into the computing system 700. The output device(s) 712 may be a display, printer, speaker, CD-writer, or another device that provides output from the computing system 700.

The communication connection(s) 716 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The terms “system” and “computing device” are used interchangeably herein. Unless the context clearly indicates otherwise, neither term implies any limitation on a type of computing system or computing device. In general, a computing system or computing device can be local or distributed and can include any combination of special-purpose hardware and/or general-purpose hardware with software implementing the functionality described herein.

While the invention has been described in connection with the disclosed embodiments, it is not intended to limit the scope of the invention to the particular form set forth, but on the contrary, it is intended to cover such alternatives, modifications, and equivalents as may be within the spirit and scope of the invention as defined by the appended claims.

What is claimed is:

1. A computerized advertising delivery system comprising:
an ad database that stores a plurality of ads, each ad providing content, in association with a uniform resource locator, to be consumed by a user;
a product database that stores information that associates each of a plurality of hostnames with one or more products, each hostname being immediately inferior to a top-level domain in an internet domain name space; and
an ad server programmed with computer-executable instructions that when executed, cause the ad server to:
retrieve ad meta-data associated with an ad stored in the ad database, the ad meta-data specifying one or more products associated with the ad;
compare the ad meta-data to product data stored in the product database to identify one or more hostnames specifying information regarding products associated with the ad; and
deliver the ad for presentation to a first user in connection with content associated with a uniform resource locator, accessible by a first hostname, stored in the ad database, wherein the ad server further encodes the ad with a second uniform resource locator associated with the first hostname, to cause content associated with the second uniform resource locator to be provided to the first user upon interaction with the ad by the first user.

2. The computerized advertising delivery system of claim 1 further comprising a registry for storing a plurality of on-network hostnames and wherein the ad server is further programmed with computer-executable instructions that when executed, cause the ad server to:
deliver the ad for presentation to a second user in connection with content associated with a uniform resource locator, accessible by a second hostname stored in the registry as an on-network hostname, stored in the ad database, wherein the ad server further encodes the ad with a second uniform resource locator associated with the second hostname, to cause content associated with the second uniform resource locator to be provided to the second user upon user interaction with the ad.

3. The computerized advertising delivery system of claim 1 wherein the ad meta-data associated with the ad stored in the ad database further comprises an on/off network flag and wherein the ad server is further programmed with computer-executable instructions that when executed, cause the ad server to:
check the on/off network ad flag;
if the on/off network ad flag indicates an on-network ad then encode the ad with the second uniform resource locator associated with the first hostname;
if the on/off network ad flag indicates an off-network ad then encode the ad with the second uniform resource locator associated with a second hostname that is different from the first hostname.

4. The computerized advertising delivery system of claim 2 wherein the ad meta-data associated with the ad stored in the ad database further comprises an on/off network flag and wherein the ad server is further programmed with computer-executable instructions that when executed, cause the ad server to:
check the on/off network ad flag;
if the on/off network ad flag indicates an on-network ad then encode the ad with the second uniform resource locator associated with the first hostname;
if the on/off network ad flag indicates an off-network ad then encode the ad with the second uniform resource locator associated with a second hostname that is different from the first hostname and that is not stored in the registry.

5. The computerized advertising delivery system of claim 4 wherein the ad server is further programmed with computer-executable instructions that when executed, cause the ad server to:
receive a third ad that is not stored in the ad database;
generate from the registry a selected hostname and selected destination uniform resource locator by selecting a hostname and a uniform resource locator associated with the selected hostname; and
provide the third ad to the selected hostname for presentation to a user upon presentation of the selected destination uniform resource locator to the user.

6. The computerized advertising delivery system of claim 4 wherein the ad server is further programmed with computer-executable instructions that when executed, cause the ad server to:
randomly select the hostname from the registry to generate the selected hostname.

7. The computerized advertising delivery system of claim 4 wherein
the registry stores a plurality of off-network hostnames; and wherein
the ad server is further programmed with computer-executable instructions that when executed, cause the ad server to:
maintain in the registry a plurality of off-network hostnames that accept ads associated with one or more on-network hostnames;
maintain in the registry a plurality on-network hostnames that accept ads associated with one or more off-network hostnames; and
check the registry to determine if a first off-network hostname accepts ads associated with one or more on-network hostnames before permitting placement of an ad originating from the first off-network hostname.

8. The computerized advertising delivery system of claim 2 wherein the ad server is further programmed with computer-executable instructions that when executed, cause the ad server to:
for each ad delivered in connection with content associated with a uniform resource locator accessible by a hostname stored in the registry as an on-network hostname, store clicks and impressions associated with the ad; and
determine whether to deliver any ad stored in the ad registry as a function of clicks and impressions associated with the ad.

9. The computerized advertising delivery system of claim 2 wherein the ad server is further programmed with computer-executable instructions that when executed, cause the ad server to:
maintain an account associated with each hostname; and
for each ad delivered in connection with content associated with a uniform resource locator accessible by a hostname stored in the registry as an on-network hostname update the account associated with the on-network hostname to cause payment of one-half of cost of the advertisement to the account associated with the hostname.

10. A computerized method for delivering advertising comprising:
retrieving ad meta-data associated with an ad stored in an ad database, the ad meta-data specifying one or more products associated with the ad, the ad database storing a plurality of ads, each ad providing content, in association with a uniform resource locator, to be consumed by a user;
comparing the ad meta-data to product data stored in a product database to identify one or more uniform resource locators specifying information regarding products associated with the ad, the product database storing information that associates each of a plurality of first level subdomains with one or more products, each first level subdomain being immediately inferior to a top-level domain in an internet domain name space; and
delivering the ad for presentation to a user in connection with content associated with a first uniform resource locator, associated with a first, first level subdomain stored in the ad database, wherein the ad server further encodes the ad with a second uniform resource locator associated with the same first level subdomain as the first uniform resource locator, to cause content associated with the second uniform resource locator to be provided to the user upon user interaction with the ad.

11. The computerized method of claim 10 further comprising:
delivering the ad for presentation to a second user in connection with content associated with a uniform resource locator, accessible by a second hostname stored in a registry as an on-network hostname, stored in the ad database, wherein the ad server further encodes the ad with a second uniform resource locator associated with the second hostname, to cause content associated with the second uniform resource locator to be provided to the second user upon user interaction with the ad, wherein the registry stores a plurality of on-network hostnames.

12. The computerized method of claim 10 wherein the ad meta-data associated with the ad stored in the ad database further comprises an on/off network flag, the method further comprising:
checking the on/off network ad flag;
if the on/off network ad flag indicates an on-network ad then encoding the ad with the second uniform resource locator associated with the first hostname;
if the on/off network ad flag indicates an off-network ad then encoding the ad with the second uniform resource locator associated with a second hostname that is different from the first hostname.

13. The computerized method of claim 11 wherein the ad meta-data associated with the ad stored in the ad database further comprises an on/off network flag, the method further comprising:
checking the on/off network ad flag;
if the on/off network ad flag indicates an on-network ad then encoding the ad with the second uniform resource locator associated with the first hostname;
if the on/off network ad flag indicates an off-network ad then encoding the ad with the second uniform resource locator associated with a second hostname that is different from the first hostname and that is not stored in the registry.

14. The computerized method of claim 13 further comprising:
receiving a third ad that is not stored in the ad database;
generating from the registry a selected hostname and selected destination uniform resource locator by selecting a hostname and a uniform resource locator associated with the selected hostname; and
providing the third ad to the selected hostname for presentation to a user upon presentation of the selected destination uniform resource locator to the user.

15. The computerized method of claim 13 further comprising:
randomly selecting the hostname from the registry to generate the selected hostname.

16. The computerized method of claim 13 wherein the registry stores a plurality of off-network hostnames, the method further comprising:
maintaining in the registry a plurality of off-network hostnames that accept ads associated with one or more on-network hostnames;
maintaining in the registry a plurality on-network hostnames that accept ads associated with one or more off-network hostnames; and
checking the registry to determine if a first off-network hostname accepts ads associated with one or more on-network hostnames before permitting placement of an ad originating from the first off-network hostname.

17. The computerized method of claim 11 further comprising:
for each ad delivered in connection with content associated with a uniform resource locator accessible by a hostname stored in the registry as an on-network hostname, storing clicks and impressions associated with the ad; and
determining whether to deliver any ad stored in the ad registry as a function of clicks and impressions associated with the ad.

18. The computerized method of claim 11 further comprising:
maintaining an account associated with each hostname; and
for each ad delivered in connection with content associated with a uniform resource locator accessible by a hostname stored in the registry as an on-network hostname updating the account associated with the on-network hostname to cause payment of one-half of cost of the advertisement to the account associated with the hostname.

19. A tangible storage medium, having stored thereupon one or more program modules comprising computer-executable instructions for execution on a computer system, the computer-executable instructions executing on a server processor to cause the computer system to perform a computer-implemented method for delivering advertising, the computer-implemented method comprising:
retrieving ad meta-data associated with an ad stored in an ad database, the ad meta-data specifying one or more products associated with the ad, the ad database storing a plurality of ads, each ad providing content, in association with a uniform resource locator, to be consumed by a user;
comparing the ad meta-data to product data stored in a product database to identify one or more uniform resource locators specifying information regarding products associated with the ad, the product database storing information that associates each of a plurality of first level subdomains with one or more products, each first level subdomain being immediately inferior to a top-level domain in an internet domain name space; and
delivering the ad for presentation to a user in connection with content associated with a first uniform resource locator, associated with a first, first level subdomain stored in the ad database, wherein the ad server further encodes the ad with a second uniform resource locato associated with the same first level subdomain as the first uniform resource locator, to cause content associated with the second uniform resource locator to be provided to the user upon user interaction with the ad.

20. The computerized method of claim 19 further comprising:
delivering the ad for presentation to a second user in connection with content associated with a uniform resource locator, accessible by a second hostname stored in a registry as an on-network hostname, stored in the ad database, wherein the ad server further encodes the ad with a second uniform resource locator associated with the second hostname, to cause content associated with the second uniform resource locator to be provided to the second user upon user interaction with the ad, wherein the registry stores a plurality of on-network hostnames.
